(19) United States
(12) Patent Application Publication
(10) Pub. No.: US 2026/0303428 A1
(43) Pub. Date: Oct. 1, 2026

(54) DEEP LEARNING-AIDED PHASE NOISE CANCELLATION FOR DISCRETE FOURIER TRANSFORM–SPREAD ORTHOGONAL FREQUENCY DIVISION MULTIPLEXING

(71) Applicant: HUAWEI TECHNOLOGIES CO., LTD., SHENZHEN (CN)

(72) Inventors: Peyman NESHAASTEGARAN, Kanata (CA); Ming JIAN, Kanata (CA)

(73) Assignee: HUAWEI TECHNOLOGIES CO., LTD., SHENZHEN (CN)

(21) Appl. No.: 19/089,765

(22) Filed: Mar. 25, 2025

(51) Int. Cl. H04L 27/26; H04B 1/04; H04L 25/02

(52) U.S. Cl. CPC H04L 27/2621; H04B 1/0475; H04L 25/0254

(57) ABSTRACT

Methods and apparatus for estimating phase noise (PN) in communication systems employing orthogonal frequency division multiplexing (OFDM) and discrete Fourier transform spreading (DFT-s). Implementations can facilitate reductions in communication overhead and improved estimations of PN. To estimate PN in a received signal, a search space of candidate PN values is constructed by a neural network based on interpolations obtained from phase-tracking pilot signals. A path metric is calculated for each candidate value to determine its likelihood, and another neural network is used weigh the candidate values and determine an optimal PN estimate within the search space for the signal. The neural networks are trained by supervised and communication-aware training.

### CROSS-REFERENCE TO RELATED APPLICATIONS

This is the first application filed for the present disclosure.

### FIELD OF THE INVENTION

The present application pertains to communication networks and in particular to methods and apparatus for orthogonal frequency division multiplexing.

### BACKGROUND

To mitigate high peak-to-average power ratios (PAPRs) in orthogonal frequency division multiplexing (OFDM), discrete Fourier transform-spread OFDM (DFT-s-OFDM) has been introduced. This variant has since been adopted for long-term evolution (LTE) and fifth generation new radio (5G-NR) wireless uplink communication, and is being considered for anticipated sub-terahertz systems. It may further see application in backhaul links of integrated access and backhaul nodes. Despite having a low PAPR, DFT-s-OFDM is susceptible to hardware impairments and, in particular, to oscillator phase noise (PN), which is time-varying and cannot be suppressed by conventional equalization techniques.

Phase-tracking reference signals (PTRSs) are typically used in communication systems that operate according to LTE and 5G-NR standards to estimate and compensate PN. The PTRSs are time-domain pilot signals that can be embedded and scattered within the DFT-s-OFDM signal as symbols. The PN can then be accurately estimated at the locations of the PTRS symbols, and through use of interpolation techniques, adjacent PTRS symbols can provide an indication of the PN that arises between the PTRS symbols. The accuracy of this interpolation, and thus the estimation of PN, improves as the separation between PTRS symbols decreases. However, to decrease this separation, the density of PTRS symbols must increase, which consequently places a greater overhead on transmissions and reduces spectral efficiency. For anticipated sixth generation (6G) communication systems, which will operate at higher frequency bands than LTE and 5G-NR systems, PN is expected to be a greater problem and to require a higher density of PTRS symbols for accurate estimation. In addition, interpolation techniques, particularly linear interpolation techniques, can be ineffective in situations where the signal-to-noise ratio is poor because the techniques assume a relatively gradual phase evolution. This can make interpolation techniques especially unreliable in noisy environments.

Therefore, there is a need for methods and apparatus for PN estimation and compensation in DFT-s-OFDM that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An aspect of implementations of the present disclosure is to provide methods and apparatus for PN estimation and mitigation, especially for DFT-s-OFDM communication.

A first aspect of the present disclosure is to provide a method for compensating PN in a data transmission sent from a sender device to a receiver device. The method may be performed at the receiver device and comprise receiving the data transmission from the sender device and obtaining from the data transmission a signal corresponding to a discrete Fourier transform-spread (DFT-s) symbol. The DFT-s symbol may include a first PTRS symbol and a second PTRS symbol separated from the first PTRS symbol by one or more data symbols. Each of the first PTRS symbol, the second PTRS symbol, and the one or more data symbols may corresponding to a respective subcarrier of a set of K subcarriers, with K being a whole number. The method may further comprise: generating, by a first neural network, a respective set of PN candidates for each time point of a set of K time points, with the set of K time points spanning the signal; determining, for each PN candidate, a respective value of a path metric in accordance with the signal and the respective PN candidate, where each value of the path metric represents a likelihood for the respective PN candidate; generating, by a second neural network, a respective weight for each PN candidate in accordance with the respective value of the path metric; determining, for each time point of the set of K time points, a respective PN estimate in accordance with the respective set of PN candidates and each respective weight therefor, where all the PN estimates form a PN sequence; and compensating the signal in accordance with the PN sequence.

In some implementations of the first aspect, the one or more data symbols may define a PTRS symbol spacing for the DFT-s symbol; and the receiver device may have associated thereto a pre-determined PN increment standard deviation. In these implementations, generating, by the first neural network, the respective set of PN candidates for each time point of the set of K time points may include: determining a respective preliminary PN estimate for each of the first PTRS symbol and the second PTRS symbol, a preliminary PN function in accordance with the respective preliminary PN estimate of each of the first PTRS symbol and the second PTRS symbol, an additive white Gaussian noise (AWGN) power for the signal, and, by the first neural network, a search factor in accordance with the pre-determined PN increment standard deviation, the PTRS symbol spacing, and the AWGN power; defining, for each time point, a respective first search region above the preliminary PN function and a respective second search region below the preliminary PN function, where each first search region and each second search region have a respective size proportional to the search factor; and generating, for each time point of the set of K time points, the respective set of PN candidates to span the respective first search region and the respective second search region. In some of these implementations, the AWGN power, the pre-determined PN increment standard deviation, and the PTRS symbol spacing may define a respective residual PN standard deviation for each time point, and the respective size of each first search region and each second search region may further be proportional to the respective PN standard deviation for the corresponding time point. In some implementations, the preliminary PN function may be an interpolation function.

In some implementations of the first aspect, for each time point of the set of K time points, the respective PN estimate may be determined by summing the respective set of PN candidates in proportion to the respective weight of each candidate of the respective set of PN candidates.

In some implementations of the first aspect, the method may further comprise determining an AWGN power for the signal and, for each PN candidate in these implementations, the respective value of the path metric may be further determined in accordance with the AWGN power.

In some implementations of the first aspect, the transmission may have associated thereto a modulation constellation including a set of constellation points, and for each PN candidate, the respective value of the path metric may be determined by summing a respective set of contributions corresponding to the set of constellation points, with each contribution depending from the corresponding constellation point. In some of these implementations, for each PN candidate, each contribution of the respective set of contributions may further depend from the signal at the time point corresponding to the respective PN candidate. In some implementations, for each PN candidate, each contribution of the respective set of contributions may further depend from the respective PN candidate.

In some implementations of the first aspect, the signal may be compensated in accordance with the PN sequence by phase de-rotation.

In some implementations of the first aspect, the method may further comprise performing a set of actions to train each of the first neural network and the second neural network. The set of actions may include: obtaining a PN measurement; determining, by a loss function, a loss value depending from the PN measurement and the PN sequence; and updating each of the first neural network and the second neural network in accordance with the loss value. In some of these implementations, the set of actions may further include: obtaining a sequence of source bits corresponding to the data transmission; determining, from the compensated signal, a respective log-likelihood ratio (LLR) for each source bit of the sequence of source bits; and determining, by a further loss function, a further loss value depending from the sequence of source bits and the respective LLR for each source bit of the sequence of source bits. In these implementations, each of the first neural network and the second neural network may be updated in accordance with each of the loss value and the further loss value. In some implementations, the first neural network and the second neural network may be updated to minimize a sum comprised between the loss value and the further loss value. In some implementations, the loss function may be a mean squared error loss function and the further loss function may be a binary cross-entropy loss function.

In some implementations of the first aspect, the first neural network may be a fully connected neural network, and the second neural network may be a two-dimensional neural network.

In some implementations of the first aspect, the DFT-s symbol may consist of the first PTRS symbol, the second PTRS symbol, and the one or more data symbols.

A second aspect of the present disclosure is to provide a network device configured to: receive a data transmission; obtain from the data transmission a signal corresponding to a DFT-s symbol, where the DFT-s symbol includes a first PTRS symbol and a second PTRS symbol separated from the first PTRS symbol by one or more data symbols with each of the first PTRS symbol, the second PTRS symbol, and the one or more data symbols corresponding to a respective subcarrier of a set of K subcarriers; generate, by a first neural network, a respective set of PN candidates for each time point of a set of K time points, with the set of K time points spanning the signal; determine, for each PN candidate, a respective value of a path metric in accordance with the signal, each value of the path metric representing a likelihood for the respective PN candidate; generate, by a second neural network, a respective weight for each PN candidate in accordance with the respective value of the path metric; determine, for each time point of the set of K time points, a respective PN estimate in accordance with the respective set of PN candidates and each respective weight therefor, where all the PN estimates form a PN sequence; and compensate the signal in accordance with the PN sequence.

A third aspect of the present disclosure is to provide a method for transmitting data from a sender device to a receiver device. The method may be performed at the sender device and comprise: obtaining a sequence of bits representing the data; mapping, by a discrete Fourier transform (DFT), the sequence of bits onto a series of subcarriers of a frequency band to form a DFT-s symbol; embedding, in the DFT-s symbol, a first PTRS symbol and a second PTRS symbol, with the first PTRS symbol corresponding to a respective further subcarrier of the frequency band preceding the series of subcarriers and the second PTRS symbol corresponding to a respective further subcarrier of the frequency band succeeding the series of subcarriers; modulating, by OFDM, the DFT-s symbol to produce a DFT-s-OFDM waveform; and transmitting, by the frequency band, the DFT-s-OFDM waveform to the receiver device.

Implementations of the first aspect may facilitate improved estimation of PN with reductions in overhead in communication employing DFT-s symbols, and more particularly, DFT-s-OFDM waveforms.

Implementations have been described above in conjunctions with aspects of the present disclosure upon which they can be implemented. Those skilled in the art will appreciate that implementations may be implemented in conjunction with the aspect with which they are described, but may also be implemented with other implementations of that aspect. When implementations are mutually exclusive, or are otherwise incompatible with each other, it will be apparent to those skilled in the art. Some implementations may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 shows a schematic for an example of a DFT-s-OFDM communication system towards which implementations of the present disclosure may be implemented.

FIG. 2 shows a schematic of examples of discrete Fourier transform-spread symbols.

FIG. 3 shows a flowchart for a method for PN estimation and mitigation, in accordance with implementations of the present disclosure.

FIG. 4 shows a plot over which an angle-time grid may be constructed as a PN search space, in accordance with an implementation of the present disclosure.

FIG. 5 shows a flowchart for a method for preparing a DFT-s-OFDM waveform, in accordance with implementations of the present disclosure.

FIG. 6 shows a plot of bit error ratio versus normalized signal-to-noise ratios for PN mitigation methods.

FIG. 7 shows a schematic of an apparatus for PN estimation and mitigation according to implementations of the present disclosure.

FIG. 8 shows a schematic of an implementation of an electronic device that may implement at least part of the methods and features of the present disclosure.

It will be noted that throughout the appended drawings, like features are identified by like reference numerals.

### DETAILED DESCRIPTION

Implementations of the present disclosure are generally directed towards PN estimation and subsequent mitigation that is aided by deep learning. Implementations may be implemented towards a signal derived from a discrete Fourier transform-spread (DFT-s) symbol sent to communicate data from a sender device to a receiver device. In implementations, a search space for determining a PN estimate for the signal may be generated by a first neural network. The search space may further be generated about a preliminary estimate of the PN determined from PTRS symbols included in the DFT-s symbol. The search space may define candidate PN values for the signal. A path metric may be calculated for the candidate PN values to determine their respective likelihoods. This information may then be provided to a second neural network to weigh the candidate PN values and determine an optimal PN estimation for the signal. The first and second neural networks may be trained by supervised and/or communication-aware training.

The present disclosure sets forth various implementations via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof.

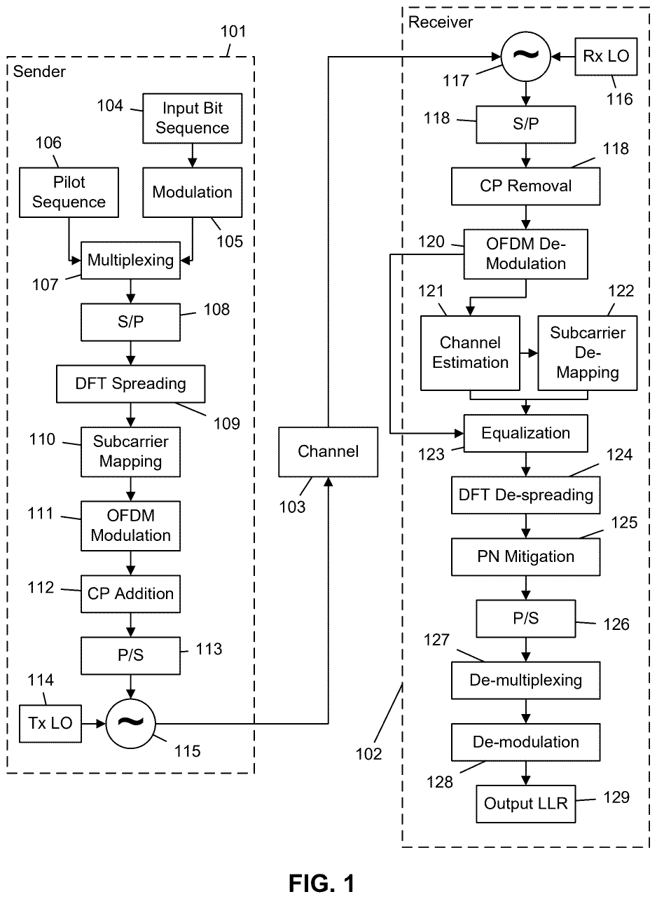

FIG. 1 shows a schematic for an example of a DFT-s-OFDM communication system, towards which implementations of the present disclosure may be implemented. The system comprises a sender device 101 connected to a receiver device 102 by a communication channel 103. The channel 103 may, for example, be a LTE, 5G-NR, 6G, microwave backhaul, or sub-terahertz communication channel. Each of the sender device 101 and the receiver device 102 may, for example, be a modem.

The sender device 101 may include a respective plurality of functional modules, including for: receiving 104 an input or source sequence of bits representing data to be sent to the receiver device 102; modulating 105 the sequence of data bits to form data signals, such as by a quadrature amplitude modulation (QAM) or pulse amplitude modulation (PAM) scheme, which may have associated thereto a modulation constellation including a set of constellation points; obtaining 106 a sequence of PTRS pilot signals; multiplexing 107 the modulated data signals with the pilot sequence to embed the PTRS pilot signals; performing 108 serial-to-parallel (S/P) conversion; spreading 109 the data and PTRS signals by discrete Fourier transform (DFT) into the frequency domain; mapping 110 the DFT-spread (DFT-s) signals to subcarriers to form a DFT-s symbol; modulating 111 the DFT-s symbol by OFDM to form a DFT-s-OFDM waveform; adding 112 a cyclic prefix (CP); performing 113 parallel-to-serial (P/S) conversion; obtaining 114 a carrier wave, such as from a local oscillator (LO); and encoding 115 the DFT-s-OFDM waveform into the carrier wave for transmission through the channel 103.

The receiver device 102 may similarly include a respective plurality of functional modules, including for: obtaining 116 a further carrier wave from a LO; mixing 117 the further carrier wave with the carrier wave transmitted through the channel 103 from the sender device 101 to extract the DFT-s-OFDM waveform; performing 118 S/P conversion; removing 119 the CP from the DFT-s-OFDM waveform; de-modulating 120 the DFT-s-OFDM waveform to obtain the DFT-s symbol; performing 121 channel estimation to obtain the channel response for each subcarrier; de-mapping 122 the subcarriers of the DFT-s symbol to obtain the DFT-s signals; performing 123 equalization; de-spreading 124 the DFT-s signals by DFT to obtain time-domain data and PTRS pilot signals; estimating 125 and mitigating PN; performing 126 P/S conversion; de-multiplexing 127 the signals to obtain the data signals; de-modulating 128 the data signals to obtain log-likelihood ratios (LLRs) corresponding to the sequence of data bits; and outputting 129 the LLRs.

A signal model can be constructed to represent the signal at the different stages of processing by the modules described in relation to FIG. 1. In the absence of DFT-s processing, the signal y for an OFDM system that is received by the receiver device 102 and affected by PN can be expressed as:

$$y = {G}_{Rx} {HG}_{Tx} s + n \qquad ( 1 )$$

where s is the signal transmitted from the sender device 101, G_{Rx} and G_{Tx} are distortion matrices for the receiver device 102 (Rx) and sender device 101 (Tx), respectively, H is a diagonal channel matrix, in the frequency domain, for the channel 103, and n is additive white Gaussian noise (AWGN). Each distortion matrix can be represented by:

$${G}_{X} = {F}_{N} {E}_{X} {F}_{N}^{- 1} , X ∈ \{ Tx , Rx \} \qquad ( 2 )$$

$$with {E}_{X} = diag \{ {e}^{j {θ}_{X} ( 0 )} , … , {e}^{j {θ}_{X} ( N - 1 )} \} \qquad ( 3 )$$

and where F_{N} and

$${F}_{N}^{- 1}$$

respectively denote a DFT matrix and its inverse, and θ_{X}(i) is the PN affecting subcarrier i of N subcarriers. The DFT matrix is of size N, with its i^{th} and j^{th} element provided by:

$${[ {F}_{N} ]}_{ij} = \frac{1}{\sqrt{N}} {e}^{- \frac{2 π ( i - 1 ) ( j - 1 )}{N}} , i , j ϵ \{ 1 , … N \} \qquad ( 4 )$$

The AWGN can be represented by a Gaussian vector with mean 0 and a covariance matrix

$${σ}_{n}^{2} {I}_{N}$$

where I_{N} is the N×N identity matrix. The PN for each subcarrier may, for example, be characterized by free-running oscillators and expressed as:

$${θ}_{X} ( i ) = {θ}_{X} ( i - 1 ) + γ ε ( i ) \qquad ( 5 )$$

where γ is a PN increment standard deviation, and ¿ (i) is a Gaussian vector with mean 0 and covariance matrix of ones. For low-pass PN, the combined effects of sender and receiver PN can be equivalently modelled as sender-only PN, such that:

$$y \approx {HG}_{TxRx} s + n \qquad ( 6 )$$

$$where$$

$${G}_{X} = {F}_{N} {E}_{Tx} {E}_{Rx} {F}_{N}^{- 1} \qquad ( 7 )$$

For a DFT-s-OFDM system, the transmitted signal s can be expressed as:

$$s = {TF}_{M} d \qquad ( 8 )$$

where d is the input time-domain signal, namely a multiplexed data-pilot vector representing the signal produced in relation to the multiplexing module 107, M is the size of the multiplexed data-pilot vector, FM is a DFT matrix applying DFT spreading, and T is a N×M subcarrier mapping matrix. Subcarrier mapping can be performed either by a localized or interleaved approach, such that the output of DFT spreading can be mapped to consecutively or uniformly spaced inputs of an OFDM modulator, respectively. In accordance with equations 6 and 8, the received signal can then be modelled, in the frequency domain, as:

$$y = {HG}_{TxRx} {TF}_{M} d + n$$

Following subcarrier de-mapping 122, channel estimation 121, and equalization 123, the processed time-domain signal x can be written as:

$$x = {\tilde{G}}_{TxRx} {F}_{M} d + w \qquad ( 10 )$$

$$where$$

$${\tilde{G}}_{TxRx} - {T}^{T} {G}_{TxRx} T \qquad ( 11 )$$

and where T^{T} is the transpose of the subcarrier mapping matrix and w is a Gaussian vector representing the AWGN after equalization with mean 0 and covariance matrix

$${σ}_{w}^{2} {I}_{M} .$$

The power of the AWGN is provided by

$${σ}_{w}^{2} .$$

This representation of the processed signal may be valid for all linear equalizers, up to a scalar adjustment. After applying de-spreading 124 by DFT, the signal can then be further processed to obtain 128 LLRs. The time-domain signal \hat{x} can be represented by:

$$\hat{x} = {F}_{M}^{- 1} {\tilde{G}}_{TxRx} {F}_{M} d + \hat{w} \qquad ( 12 )$$

This representation can be further simplified by the approximation:

$$\hat{E} = {F}_{M}^{- 1} {\tilde{G}}_{TxRx} {F}_{M} = diag \{ {e}^{j ϕ ( 0 )} , … , {e}^{j ϕ ( M - 1 )} \} \qquad ( 13 )$$

where φ(m) is the PN affecting the m^{th} element of the time-domain signal, having size M. In this case the model for the system can be written as:

$$\hat{x} = \hat{E} d + \hat{w} \qquad ( 14 )$$

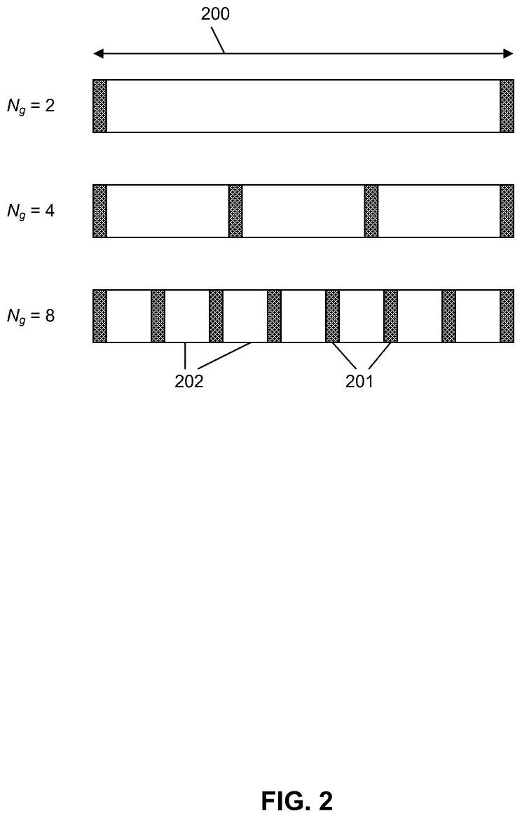

Current techniques for estimating PN 125 for a DFT-s symbol typically rely exclusively on determining the PN for PTRS symbols embedded in the DFT-s symbol and interpolating these results for the data carried between the PTRS symbols. FIG. 2 shows a schematic for an example of DFT-s symbols 200 spanning a length of subcarrier frequencies with PTRS symbols 201 (shaded regions) embedded therein. A plurality of PTRS symbols 201 may be grouped within each shaded region shown in FIG. 2. The number of groups in each DFT-s symbol is indicated by Ng. Data symbols 202 may be interspersed between the groups of PTRS symbols 201. The positions of each PTRS symbol 201 or group thereof in the DFT-s symbol are typically pre-determined. Herein, the total number of data symbols and PTRS symbols corresponds to the size of the multiplexed data vector and is likewise represented by M, M is a natural number. To achieve high accuracy estimates with interpolation techniques, high densities of PTRS symbols 201 or groups thereof are needed. This overhead reduces the spectral efficiency of transmissions.

Implementations of the present disclosure are generally directed towards providing methods and apparatus for PN estimation and mitigation that reduces the reliance on high densities of PTRS symbols. In implementations, deep learning may be used to estimate PN by exploiting information contained in all signals received, not just that respective to PTRS symbols. In particular, neural networks (NNs) may be used to conduct a search space around a PN estimate provided by an interpolation technique and to determine an optimal PN sequence for the DFT-s symbol within that search space. This approach may enable as few as two PTRS symbols to be embedded in a DFT-s symbol for accurate PN estimation.

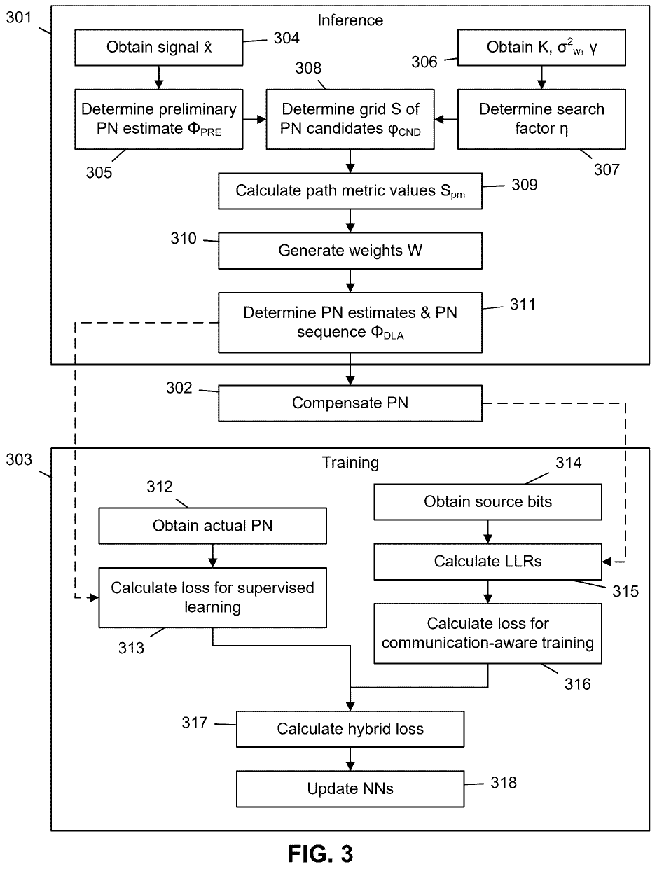

FIG. 3 shows a flowchart for a method for PN estimation and mitigation, in accordance with implementations of the present disclosure. The method may be performed at a receiver device 102 configured similarly to that shown in FIG. 1. The method comprises: a first set of actions for inference 301 of PN by a plurality of NNs and subsequent compensation 302 of the PN, which may be implemented together as the module for estimating 125 and mitigating PN, as described in relation to FIG. 1; and a second set of actions for training 303 the plurality of NNs, which may include processing by the modules for de-modulating 128 the data signals and outputting 129 LLRs.

The first set of actions for inference 301 may comprise actions 304 to 311. At action 304, a signal corresponding to a DFT-s symbol may be obtained from a data transmission received by the receiver device 102. The data transmission may be received from a sender device 101 through a communication channel 103. The signal obtained may, for example, be represented by R, as defined by equations 12 or 14. The DFT-s symbol may, for example, have been prepared with zero-tail DFT spreading or other variations of DFT spreading. The DFT-s symbol may include a first PTRS symbol and a second PTRS symbol separated from the first PTRS symbol by one or more data symbols. Each of the first PTRS symbol, the second PTRS symbol, and the one or more data symbols may have corresponded to a respective subcarrier of a set of set of K subcarriers, where K is a natural number and represents the separation between the first and second PTRS symbols. The set of K subcarriers may belong to a group of M subcarriers to which the symbols of the DFT-s symbol were mapped for transmission. In some implementations, the DFT-s symbol may only comprise the first PTRS symbol, the second PTRS symbol, and the one or more data symbols, such that the first PTRS symbol corresponds to the first subcarrier and the second PTRS symbol corresponds to the last subcarrier of the data transmission. In other words, in these implementations, only two PTRS symbols may be embedded in the DFT-s symbol, one at the beginning and the other at the end. In cases where only two PTRS symbols are embedded, at the first and last positions, K may equal M. In some other implementations, K may not equal M. In these implementations more than two PTRS symbols may be embedded in the DFT-s symbol. Each PTRS symbol may be separated from each other adjacent PTRS symbol according to spacing K. Each pair of adjacent PTRS symbols and the data symbols therebetween may then correspond to a respective set of K subcarriers of the group of M subcarriers. In these cases, the method described herein may be performed for each pairing of adjacent PTRS symbols, such that PN can be estimated and mitigated for the entire DFT-s symbol. At action 305, a preliminary PN function OPRE may be determined for the DFT-s symbol, such as by an interpolation function. The interpolation function may, for example, be a linear interpolation (LI).

At action 306, the PTRS symbol spacing K may be obtained as well as the power of the AWGN

$${σ}_{w}^{2}$$

and the PN increment standard deviation γ. The PN increment standard deviation may be associated with a hardware aspect of the receiver device 102. The AWGN power may be determined from demodulation reference signals (DMRSs) included in the transmission prior to OFDM modulation 111. The quantities, K,

$${σ}_{w}^{2} ,$$

and γ, may then be input into a first NN to determine, at action 307, a search factor η that may be used to construct a search space, at action 308, for determining an optimal PN sequence. The first NN may, for example, be a fully connected NN and referred to as a grid construction NN (GCNN). The search space may span the full duration of the signal, represented by a group of M time points. The group of M time points may comprise one or more sets of K time points, depending on whether two or more PTRS symbols are embedded in the DFT-s symbol. The search space may further span a respective set of L+1 PN candidates generated for each time point of the set of time points, where L is a natural number. The search factor may determine the size of the span of each set of PN candidates. Thus, the search space may comprise a M×(L+1) angle-time grid S formed between the set of time points and each time point's respective set of PN candidates. Being based on parameters respective to the communication system comprising the receiver device 102 and the sender device 101, the search factor may be considered to tailor the search space to the specific configuration of the communication system. In some implementations, each set of PN candidates may be approximately centered about a respective value of the preliminary PN function that corresponds to the respective time point. In these cases, the search space may comprise, for each time point, a respective first search region above the preliminary PN function and a respective second search region below the preliminary PN function. Each first search region and each second search region may have a respective size that is proportional to the search factor. For example, the respective size of the first search region and the second search region for the k^{th} time point within a set of K time points may be given by ησ_{PRE}(k) where σ_{PRE}(k) is the standard deviation of residual PN at the k^{th} point, as provided by:

$${σ}_{PRE} ( k ) = \sqrt{k ( 1 - \frac{k}{K} ) {γ}^{2} + ( 1 - 2 \frac{k}{K} + 2 \frac{{k}^{2}}{{K}^{2}} ) {σ}_{w}^{2}} \qquad ( 15 )$$

In this case, the search space may extend up to φ_{PRE}(k)+ησ_{PRE}(k) and down to φ_{PRE}(k)−ησ_{PRE}(k) for the k^{th} time point. Furthermore, the 1^{th} PN candidate φ_{CND}(k, l) of the respective set of PN candidates for the k^{th} time point may be generated according to:

$${ϕ}_{CND} ( l , k ) = {ϕ}_{PRE} ( k ) + ( l - \frac{L}{2} ) \frac{2 η {σ}_{PRE} ( k )}{L} , 0 \leq l \leq L \qquad ( 16 )$$

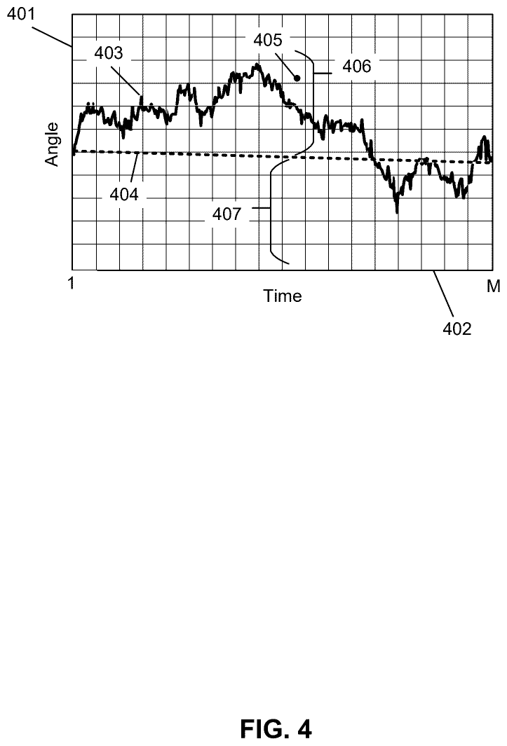

An example of a search space developed according to this formulation is shown in FIG. 4 and is described further hereinbelow.

At action 309, a respective value for a path metric may be determined for each PN candidate generated as part of the search space at action 308. Each value of the path metric may represent the likelihood that the respective PN candidate matches the actual PN for the corresponding time point. In other words, the path metric may represent the reliability of PN candidates. The value of the path metric S_{PM}(l, k) for the 1^{th} PN candidate at the k^{th} time point for a set of K time points may, for example, be calculated according to a sum of contributions, as provided by:

$${S}_{PM} ( l , k ) = {\sum }_{i = 1}^{\vert C \vert} exp ( - \frac{{\vert \hat{x} ( k ) - {d}_{i} {e}^{j {ϕ}_{CND} ( l , k )} \vert}^{2}}{2 {σ}_{w}^{2}} ) \qquad ( 17 )$$

where \hat{x}(k) is the received signal at the k^{th} time point, such as given by equation 14, i is an index over |C| constellation points used in modulation of the signal, and di is the input signal for the i^{th} constellation point. Calculation of the path metric may enable efficient searching for the optimal PN sequence by narrowing the search space, which may include (L+1)^{M} possible sequences for the whole group of M time points.

At action 310, a second NN may be used to generate a respective weight for each PN candidate in accordance with the respective value of the path metric. The second NN may, for example, be a two-dimensional NN and referred to as a weight estimation NN (WENN). The second NN may receive the values of the path metric S_{PM} as input to capture interdependencies between the time and angle dimensions of the search space. The weights may be selected to minimize the influence of variations in the signal on the PN estimation process and produce optimal PN estimates. A respective deep-learning aided (DLA) PN estimate φ_{DLA}(k) (or more simply referred to as a ‘PN estimate’) may be determined for each time point, at action 311, in accordance with the weights output from the second NN. Each PN estimate may, for example, be determined by summing the respective set of PN candidates in proportion to their respective weights, as provided by:

$${ϕ}_{DLA} ( k ) = {\sum }_{l = 0}^{L} W ( l , k ) {ϕ}_{CND} ( l , k )$$

where W(l, k) is the lth weight for the k^{th} time point of a set of K time points within a group of M time points. All the PN estimates may form a sequence (i.e., a PN sequence) that can be used to compensate the PN in the signal.

At action 302, the signal may be compensated for PN, such as by de-rotation, in accordance with the PN sequence estimated from the first set of actions for inference 301. The resulting signal may be referred to as a PN-corrected or compensated signal.

The second set of actions for training 303 may comprise actions 312 to 318. The second set of actions may be directed towards jointly training the first and second NNs to refine the estimated PN sequences produced from inference 301. In some implementations, the training may involve supervised learning, which may include calculation of a first loss through actions 312 and 313. At action 312, an actual or ground-truth PN do (i.e., a ‘PN measurement’) may be obtained for the compensated signal processed by the receiver device 102. At action 313, a loss value [symbol] (i.e., the first loss) may be calculated by a loss function that depends on the PN measurement and the PN sequence. The loss function may, for example, be a mean squared error (MSE) loss function, such that [symbol] =MSE(φ₀, φ_{DLA}). Each of the first and second NNs may be updated in accordance with the loss value. Updating the NNs may include updating one or more respective weights and/or one or more respective biases of the NNs. In some implementations, training may further involve communication-aware training, which may include calculation of a second loss through actions 314 to 316. At action 314, the input or source sequence of bits representing the data of the signal may be obtained. At action 315, a respective LLR for each bit of the source sequence of bits may be calculated from the PN-corrected signal. At action 316, the calculated LLRs Λ_{DLA} may be compared against the source sequence of bits b by a further loss function to determine a further loss value [symbol] (i.e., the second loss). The further loss function may, for example, be a binary cross-entropy (BCE) loss function, such that [symbol] =BCE(b, Λ_{DLA}). Each of the first and second NNs may be updated in accordance with the further loss value. In some implementations, a hybrid or total loss [symbol] may be calculated from the loss value and the further loss value, such as by summing them. At action 318, each of the first and second NNs may be updated according to the total loss, which may include updating the NNs to minimize the total loss.

FIG. 4 shows a plot over which an angle-time grid may be constructed for a signal received by a receiver device 102, in accordance with an implementation of the present disclosure. The grid may be constructed over angle 401 and time 402 dimensions, with time 402 spanning M. The plot includes a trace of the actual PN 403 for the signal and a trace representing the preliminary PN function ØPRE 404, which in this case is shown as a linear interpolation. The plot further includes an example of a PN candidate 405 for one time point among the M time points as well as indications of the respective first search region 406 extending above the preliminary PN function 404 and the respective second search region 407 extending below the preliminary PN function 404 for the one time point.

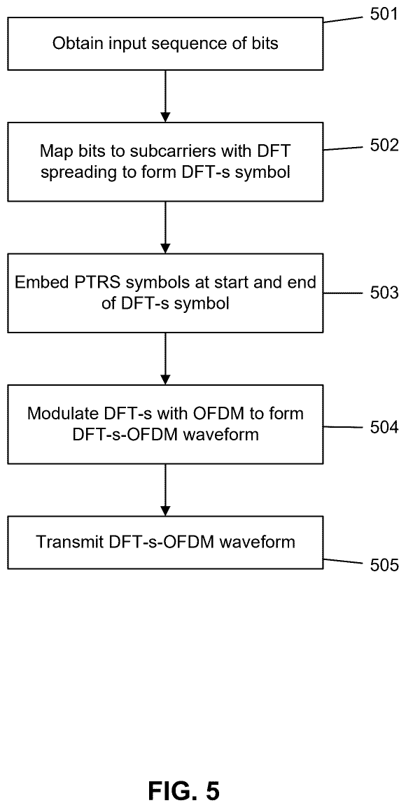

FIG. 5 shows a flowchart for a method for preparing a DFT-s-OFDM waveform, in accordance with implementations of the present disclosure. The DFT-s-OFDM waveform may correspond to a DFT-s symbol with only two PTRS symbols embedded therein, at the start and end, as described previously in relation to FIG. 3. The method may be performed by a sender device 101, such as that described in relation to FIG. 1. At action 501, an input or source sequence of bits representing data may be obtained. At action 502, the sequence of bits may be mapped, by DFT, onto a series of subcarriers of a frequency band to form a DFT-s symbol. At action 503, each of a first PTRS symbol and a second PTRS symbol may be embedded in the DFT-s symbol. The first PTRS symbol may be embedded to correspond to a respective further subcarrier of the frequence band that precedes the series of subcarriers. The second PTRS symbol may be embedded to correspond to a respective further subcarrier of the frequency band that succeeds the series of subcarriers. In other words, the PTRS symbol may be embedded at the beginning of the DFT-s symbol and the second PTRS symbol may be embedded at the end of the DFT-s symbol. At action 504, the DFT-s symbol may be modulated by OFDM to form a DFT-s-OFDM waveform. At action 505, the DFT-s-OFDM waveform may be transmitted by the frequency band to the receiver device 102.

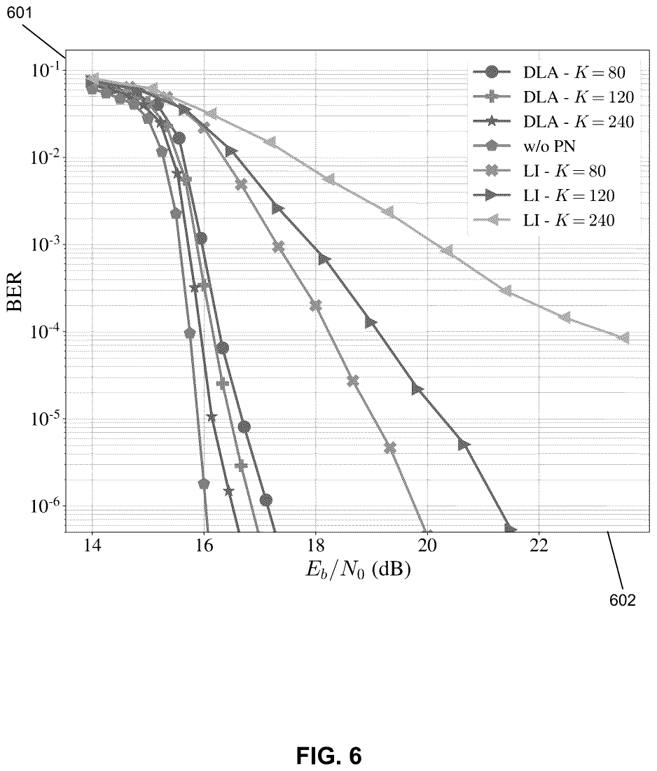

FIG. 6 shows an example plot of bit error rate (BER) 601 versus normalized signal-to-noise ratio (Eb/No in dB) 602 for DFT-s symbols processed with PN mitigation according to typical linear interpolation (LI) and according to methods of the present disclosure (DLA). Traces are shown for various PTRS symbol spacings K. A trace is also included for a case without (w/o) PN present in the signal. The plot shows that the performance for LI, as measured by BER 601, becomes generally worse as the PTRS symbol spacing increases. In contrast, the performance for DLA becomes generally better as the PTRS symbol spacing increases. The plot further shows that the DLA methods for PN mitigation significantly improve performance in comparison to the typical LI methods, such that the performance approaches that for the case where PN is absent. Thus, implementations of the present disclosure may facilitate superior PN mitigation with lower overhead.

Implementations of the present disclosure may be implemented using electronics hardware, software, or a combination thereof. In some implementations, the disclosure may be implemented by one or multiple computer processors executing program instructions stored in memory. In some implementations, the disclosure may be implemented partially or fully in hardware, for example using one or more field programmable gate arrays (FPGAs) or application specific integrated circuits (ASICs) to rapidly perform processing operations.

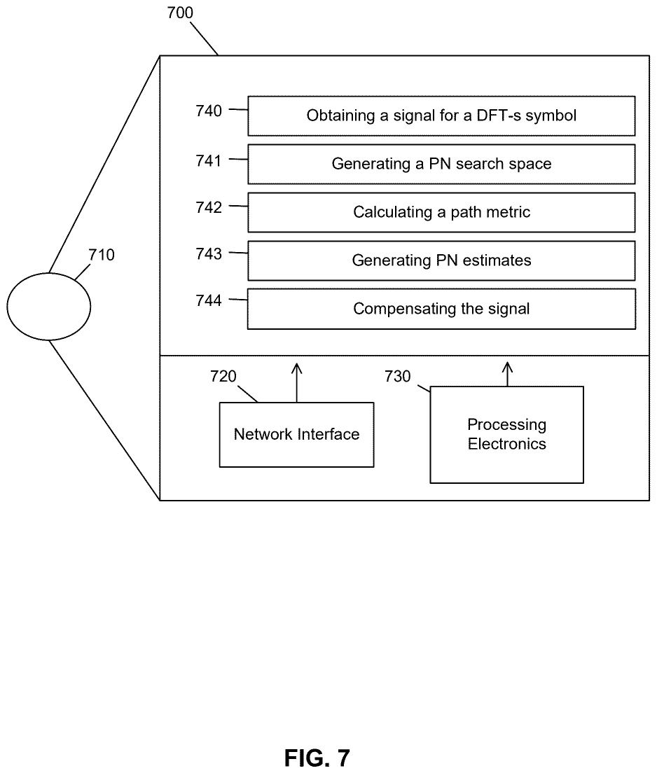

FIG. 7 shows an apparatus 700 for PN estimation and mitigation, according to implementations of the present disclosure. The apparatus 700 may be located at a node 710 of a network. The apparatus may include a network interface 720 and processing electronics 730. The processing electronics 730 may include a computer processor executing program instructions stored in memory, or other electronics components such as digital circuitry, including for example FPGAs and ASICs. The network interface 720 may include an optical communication interface or radio communication interface, such as a transmitter and receiver. The apparatus 700 may include several functional components, each of which may be partially or fully implemented using the underlying network interface 720 and processing electronics 730. Examples of functional components may include modules for obtaining 740 a signal for a DFT-s symbol, generating 741 a PN search space, calculating 742 a path metric, generating 743 PN estimates, and compensating 744 the signal.

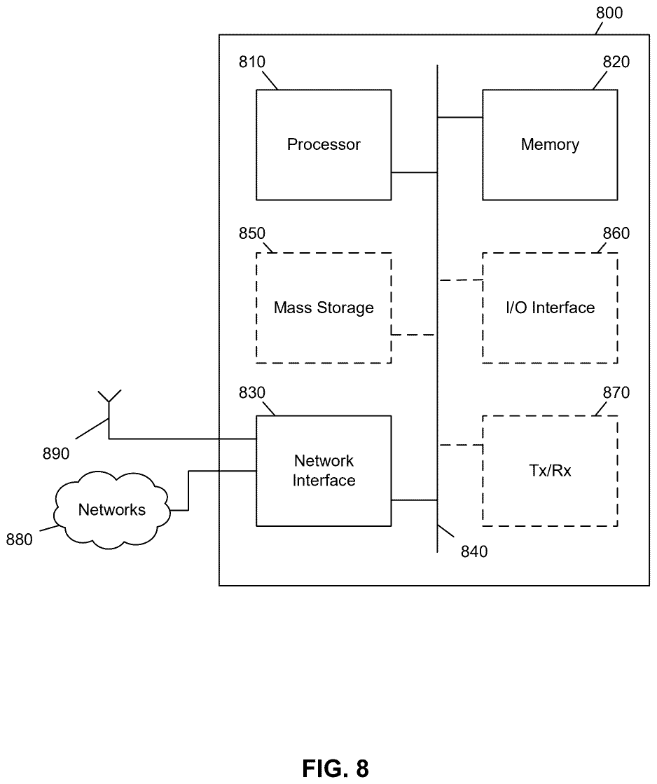

FIG. 8 shows a schematic diagram of an electronic device 800 that may perform any or all of the operations of the above methods and features explicitly or implicitly described herein, according to different implementations of the present disclosure. For example, a computer equipped with network function may be configured as electronic device 800. The electronic device 800 may be used to implement the apparatus 700 of FIG. 7, for example. The electronic device 800 may further be used as part of a sender device 101 and/or a receiver device 102, for example.

As shown, the electronic device 800 may include a processor 810, such as a Central Processing Unit (CPU) or specialized processors such as a Graphics Processing Unit (GPU) or other such processor unit, memory 820, network interface 830, and a bi-directional bus 840 to communicatively couple the components of electronic device 800. Electronic device 800 may also optionally include non-transitory mass storage 850, an I/O interface 860, and a transceiver 870. According to certain implementations, any or all of the depicted elements may be utilized, or only a subset of the elements. Further, the electronic device 800 may contain multiple instances of certain elements, such as multiple processors, memories, or transceivers. Also, elements of the hardware device may be directly coupled to other elements without the bi-directional bus 840. Additionally or alternatively to a processor and memory, other electronics, such as integrated circuits, may be employed for performing the required logical operations.

The memory 820 may include any type of tangible, non-transitory memory such as static random access memory (SRAM), dynamic random access memory (DRAM), synchronous DRAM (SDRAM), read-only memory (ROM), any combination of such, or the like. The mass storage element 850 may include any type of tangible, non-transitory storage device, such as a solid state drive, hard disk drive, a magnetic disk drive, an optical disk drive, USB drive, or any computer program product configured to store data and machine executable program code. According to certain implementations, the memory 820 or mass storage 850 may have recorded thereon statements and instructions executable by the processor 810 for performing any of the aforementioned method operations described above.

Network interface 830 may include at least one of a wired network interface and a wireless network interface. The network interface 830 may include a wired network interface to connect to a communication network 880 and may also include a radio access network interface 890 for connecting to the communication network 880 or other network elements over a radio link. The network interface 830 enables the electronic device 800 to communicate with remote entities such as those connected to the communication network 880.

It will be appreciated that, although specific implementations of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding implementations, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the implementations of the present disclosure. For example, such an execution may correspond to a simulation of the logical operations as described herein. The software product may additionally or alternatively include number of instructions that enable a computer device to execute operations for configuring or programming a digital logic apparatus in accordance with implementations of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

Although a combination of features is shown in the illustrated implementations, not all of them need to be combined to realize the benefits of various implementations of this disclosure. In other words, a system or method designed according to an implementation of this disclosure will not necessarily include all features shown in any one of the Figures or all portions schematically shown in the Figures. Moreover, selected features of one example implementation may be combined with selected features of other example implementations.

Although the present disclosure has been described with reference to specific features and implementations thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A method for compensating phase noise (PN) in a data transmission sent from a sender device to a receiver device, the method comprising, at the receiver device:
receiving the data transmission from the sender device;
obtaining from the data transmission a signal corresponding to a discrete Fourier transform-spread (DFT-s) symbol, the DFT-s symbol including a first phase-tracking reference signal (PTRS) symbol and a second PTRS symbol separated from the first PTRS symbol by one or more data symbols, each of the first PTRS symbol, the second PTRS symbol, and the one or more data symbols corresponding to a respective subcarrier of a set of K subcarriers, K being a whole number;
generating, by a first neural network, a respective set of PN candidates for each time point of a set of K time points, the set of K time points spanning the signal;
determining, for each PN candidate, a respective value of a path metric in accordance with the signal and the respective PN candidate, each value of the path metric representing a likelihood for the respective PN candidate;
generating, by a second neural network, a respective weight for each PN candidate in accordance with the respective value of the path metric;
determining, for each time point of the set of K time points, a respective PN estimate in accordance with the respective set of PN candidates and each respective weight therefor, all the PN estimates forming a PN sequence;
and
compensating the signal in accordance with the PN sequence.

2. The method of claim 1 wherein:
the one or more data symbols define a PTRS symbol spacing for the DFT-s symbol;
the receiver device has associated thereto a pre-determined PN increment standard deviation;
and
generating, by the first neural network, the respective set of PN candidates for each time point of the set of K time points includes:
determining:
a respective preliminary PN estimate for each of the first PTRS symbol and the second PTRS symbol,
a preliminary PN function in accordance with the respective preliminary PN estimate of each of the first PTRS symbol and the second PTRS symbol,
an additive white Gaussian noise (AWGN) power for the signal,
and,
by the first neural network, a search factor in accordance with the pre-determined PN increment standard deviation, the PTRS symbol spacing, and the AWGN power;
defining, for each time point, a respective first search region above the preliminary PN function and a respective second search region below the preliminary PN function, each first search region and each second search region having a respective size proportional to the search factor;
and
generating, for each time point of the set of K time points, the respective set of PN candidates to span the respective first search region and the respective second search region.

3. The method of claim 2 wherein:
the AWGN power, the pre-determined PN increment standard deviation, and the PTRS
symbol spacing define a respective residual PN standard deviation for each time point; and
the respective size of each first search region and each second search region is further proportional to the respective PN standard deviation for the corresponding time point.

4. The method of claim 2 wherein the preliminary PN function is an interpolation function.

5. The method of claim 1 wherein, for each time point of the set of K time points, the respective PN estimate is determined by summing the respective set of PN candidates in proportion to the respective weight of each candidate of the respective set of PN candidates.

6. The method of claim 1 wherein:
the method further comprises, at the receiver device:
determining an additive white Gaussian noise (AWGN) power for the signal;
and,
for each PN candidate, the respective value of the path metric is further determined in accordance with the AWGN power.

7. The method of claim 1 wherein:
the transmission has associated thereto a modulation constellation including a set of constellation points;
and,
for each PN candidate, the respective value of the path metric is determined by summing a respective set of contributions corresponding to the set of constellation points, each contribution depending from the corresponding constellation point.

8. The method of claim 7 wherein, for each PN candidate, each contribution of the respective set of contributions further depends from the signal at the time point corresponding to the respective PN candidate.

9. The method of claim 7 wherein, for each PN candidate, each contribution of the respective set of contributions further depends from the respective PN candidate.

10. The method of claim 1 wherein the signal is compensated in accordance with the PN sequence by phase de-rotation.

11. The method of claim 1 further comprising, at the receiver device:
performing a set of actions to train each of the first neural network and the second neural network, the set of actions including:
obtaining a PN measurement;
determining, by a loss function, a loss value depending from the PN measurement and the PN sequence;
and
updating each of the first neural network and the second neural network in accordance with the loss value.

12. The method of claim 11 wherein:
the set of actions further includes:
obtaining a sequence of source bits corresponding to the data transmission;
determining, from the compensated signal, a respective log-likelihood ratio (LLR) for each source bit of the sequence of source bits;
and
determining, by a further loss function, a further loss value depending from the sequence of source bits and the respective LLR for each source bit of the sequence of source bits;
and
each of the first neural network and the second neural network are updated in accordance with each of the loss value and the further loss value.

13. The method of claim 12 wherein the first neural network and the second neural network are updated to minimize a sum comprised between the loss value and the further loss value.

14. The method of claim 11 wherein the loss function is a mean squared error loss function.

15. The method of claim 12 wherein the further loss function is a binary cross-entropy loss function.

16. The method of claim 1 wherein the first neural network is a fully connected neural network.

17. The method of claim 1 wherein the second neural network is a two-dimensional neural network.

18. The method of claim 1 wherein the DFT-s symbol consists of the first PTRS symbol, the second PTRS symbol, and the one or more data symbols.

19. A network device configured to:
receive a data transmission;
obtain from the data transmission a signal corresponding to a discrete Fourier transform-spread (DFT-s) symbol, the DFT-s symbol including a first phase-tracking reference signal (PTRS) symbol and a second PTRS symbol separated from the first PTRS symbol by one or more data symbols, each of the first PTRS symbol, the second PTRS symbol, and the one or more data symbols corresponding to a respective subcarrier of a set of K subcarriers, K being a whole number;
generate, by a first neural network, a respective set of PN candidates for each time point of a set of K time points, the set of K time points spanning the signal;
determine, for each PN candidate, a respective value of a path metric in accordance with the signal, each value of the path metric representing a likelihood for the respective PN candidate;
generate, by a second neural network, a respective weight for each PN candidate in accordance with the respective value of the path metric;
determine, for each time point of the set of K time points, a respective PN estimate in accordance with the respective set of PN candidates and each respective weight therefor, all the PN estimates forming a PN sequence;
and
compensate the signal in accordance with the PN sequence.

20. A method for transmitting data from a sender device to a receiver device, the method comprising, at the sender device:
obtaining a sequence of bits representing the data;
mapping, by a discrete Fourier transform (DFT), the sequence of bits onto a series of subcarriers of a frequency band to form a DFT-spread symbol;
embedding, in the DFT-spread symbol, a first phase-tracking reference signal (PTRS) symbol and a second PTRS symbol, the first PTRS symbol corresponding to a respective further subcarrier of the frequency band preceding the series of subcarriers, the second PTRS symbol corresponding to a respective further subcarrier of the frequency band succeeding the series of subcarriers;
modulating, by orthogonal frequency division multiplexing (OFDM), the DFT-spread symbol to produce a DFT-s-OFDM waveform;
and
transmitting, by the frequency band, the DFT-s-OFDM waveform to the receiver device.
